(19) United States
(12) Patent Application Publication
(10) Pub. No.: US 2023/0045926 A1
(43) Pub. Date: Feb. 16, 2023

(54) TRIMMING DEVICE, COATING DEVICE, AND METHOD FOR TRIMMING A NARROW-SURFACE COATING MATERIAL

(71) Applicant: HOMAG GmbH, Schopfloch (DE)

(72) Inventors: Jonathan WÜRZ, Dornhan (DE); Felix SCHULZ, Aalen (DE)

(21) Appl. No.: 17/785,768

(22) PCT Filed: Dec. 18, 2020
(86) PCT No.: PCT/EP2020/087109

§ 371 Date: Jun. 15, 2022

(30) Foreign Application Priority Data
Dec. 20, 2019 (DE) 10 2019 135 438.2

(51) Int. Cl. B27D 5/00

(52) U.S. Cl. CPC B27D 5/006; B27D 5/003

(57) ABSTRACT

The invention relates to a trimming device (21), in particular for a coating device (10) for coating narrow surfaces (12) of planar workpieces (11), having a cutting tool (22) by means of which a cutting movement (S) can be performed in order to trim a narrow-surface coating material (13), wherein the cutting tool (22) comprises a cutting region to which the narrow-surface coating material (13) can be transported in a direction of movement (B), wherein an adjusting device (23) is provided by means of which an adjusting movement (W) of the cutting tool (22) can be controlled in order to trim the narrow-surface coating material (13), wherein the adjusting movement (W) has at least one directional component directed in the direction of movement (B) of the narrow-surface coating material (13), as well as to a coating device (10) for coating narrow surfaces (12) of planar workpieces (11) with a narrow-surface coating material (13), and to a method for trimming a narrow-surface coating material (13) with a trimming device (21).

### TECHNICAL FIELD

The invention relates to a trimming device for trimming a narrow-surface coating material, a coating device comprising a trimming device of this kind, and a method for trimming a narrow-surface coating material.

### PRIOR ART

In the field of furniture and component production, workpieces are often provided with a coating material for aesthetic and also functional reasons, wherein planar workpieces are mostly also coated on their narrow surfaces with a narrow-surface coating or edge material. In particular if the narrow-surface coating material is to be applied fully along the narrow surface of a workpiece, for example in the case of a peripheral tabletop edge, it is necessary to form an exact joint region between the two ends of the narrow-surface coating material. For this purpose, the narrow-surface coating material must be trimmed to an optimal length, and therefore coating devices have a corresponding trimming device. Coating devices which operate in a continuous feed process, i.e., the workpiece is transported relative to the coating device, can have track guided trimming devices in order to trim the narrow-surface coating material. On account of the overall size of such track guided trimming devices, however, fixed trimming devices are mostly used in stationary technology, for example in the case of CNC controlled coating devices, which require the feed to be stopped in order to trim the narrow-surface coating material. Besides extended processing times, the stopping of the feed can lead to a disruption in the processing device since the entire apparatus must be stopped and accelerated again. If the narrow-surface coating material has a functional layer to be activated, an increased energy input to activate the functional layer can additionally occur locally as a result of the stopping of the feed, which can lead to a deterioration in quality, in particular in the case of zero joint technology.

### SUMMARY OF THE INVENTION

The object of the present invention is to provide a trimming device by means of which short processing times when trimming a narrow-surface coating material are made possible. In addition, the object of the present invention is to provide a coating device which allows a time and cost efficient coating of narrow surfaces of planar workpieces. Furthermore, it is the object of the present invention to provide a method for time and cost efficient trimming of a narrow-surface coating material.

This object is achieved by a trimming device, in particular for a coating device for coating narrow surfaces of planar workpieces, said trimming device having a cutting tool which can perform a cutting movement in order to trim a narrow-surface coating material, wherein the cutting tool has a cutting region to which the narrow-surface coating material can be transported in a direction of movement, wherein an adjusting device is provided which can control an adjusting movement of the cutting tool in order to trim the narrow-surface coating material, wherein the adjusting movement has at least one directional component directed in the direction of movement of the narrow-surface coating material. Such a trimming device makes it possible to trim the narrow-surface coating material without interrupting a transport movement of the narrow-surface coating material. In this case, the narrow-surface coating material can be trimmed to an optimal length, so that it can be applied to the narrow surface in the necessary length. The adjusting device in this case allows a cutting tool adjusting movement which has at least one directional component directed in the direction of the direction of movement of the narrow-surface coating material. In this way, the cutting tool can perform the adjusting movement in accordance with the transport movement of the narrow-surface coating material and can sever the narrow-surface coating material by carrying out the cutting movement. Here, the cutting movement is in particular a feed movement of the cutting tool in the direction of the narrow-surface coating material but can also be the simple execution of a cut or saw cut by the cutting tool.

In a preferred embodiment of the trimming device, it can be provided that the adjusting device has at least one guide, preferably at least one linear guide or cross guide, by means of which a guided adjusting movement and/or cutting movement of the cutting tool is provided. A precise adjusting movement and/or cutting movement can b e formed by the guide, in particular by the linear guide, so that an exact trimming of the narrow-surface coating material is made possible. In addition, it can be provided by the cross guide that the adjusting movement and the cutting movement can be performed in a superposed manner.

A further preferred embodiment of the trimming device can provide that the adjusting movement of the cutting tool and the cutting movement of the cutting tool can be performed simultaneously. Due to the simultaneous performance of the adjusting movement and of the cutting movement, the cutting tool can be moved towards the narrow-surface coating material and at the same time perform the cutting movement for severing the narrow-surface coating material. An interruption of the transport movement of the narrow-surface coating material for the purpose of trimming or in order to perform a cutting movement is therefore unnecessary.

In an advantageous further development of the trimming device, it can b e provided that the adjusting movement of the cutting tool is provided substantially parallel to the direction of movement of the narrow-surface coating material. It is thus possible to prevent a canting of the cutting tool while the narrow-surface coating material is being severed, and therefore a precise cutting edge, for example to form an aesthetically pleasing joint between two ends of the narrow-surface coating material, can be produced.

The adjusting device of the trimming device can preferably have at least one drive device, which controls at least the adjusting movement of the cutting tool from a starting position, wherein a speed of the adjusting movement of the cutting tool can be matched to a transport speed of the narrow-surface coating material. The trimming process can be automated by the drive device, wherein the drive device allows a synchronization of the adjusting movement of the cutting tool to the transport movement of the narrow-surface coating material. For this purpose, the drive device can comprise a corresponding control and/or sensor unit.

The drive device can advantageously be formed as an energy storage element, drive cylinder, drive motor or as a comparable adjusting drive and can preferably have a synchronization device, which matches the speed of the adjusting movement of the cutting tool to the transport speed of the narrow-surface coating material. Such a drive device allows both a constructionally simple and cost effective embodiment of the trimming device.

In a particularly preferred embodiment of the trimming device, the drive device can be formed as a clamping device, which, in a clamping position, b ears against or engages the narrow-surface coating material in a non-slip manner so that the clamping device in the clamping position can be entrained by the transport movement of the narrow-surface coating material. Such a clamping device allows a mechanical design of the drive device. Since the clamping device, by way of the transfer into the clamping position, forms a frictionally engaged connection with the moving narrow-surface coating material, a precise synchronization between the transport movement of the narrow-surface coating material and the adjusting movement of the cutting tool can thus be provided in a simple way.

An advantageous further development of the clamping device can provide that at least two mutually opposed clamping elements are provided, which can be transferred from a material pass through position into the clamping position, wherein the narrow-surface coating material is transportable between the clamping elements, and the clamping elements, in the clamping position, bear against or engage the narrow-surface coating material. The clamping elements can have corresponding contact faces, which in the clamping position bear against the narrow-surface coating material. A sufficient static friction can thus be formed between the narrow-surface coating material and the clamping elements, which allows non-slip bearing contact or engagement. This can be additionally influenced by the contact faces having a corresponding profiling or structuring or being formed from a material that has a high static friction coefficient.

In a preferred embodiment of the trimming device, it can be provided that the at least two clamping elements have recesses corresponding to one another, into which the cutting tool at least partly dips when the cutting movement is being performed. Since the narrow-surface coating material has a much smaller thickness in comparison to its width and is thus correspondingly flexible, it may be advantageous to fix the narrow-surface coating material while it is being severed. This fixing is provided by the clamping elements, wherein the recesses for the cutting tool allow the narrow-surface coating material to be severed in the direct vicinity of the clamping elements.

In a further preferred embodiment of the trimming device, it can be provided that the adjusting device has at least one resetting device, preferably an energy storage element, a drive cylinder, a drive motor or a comparable resetting drive, by means of which a resetting movement of the cutting tool into the starting position can be controlled following the trimming of the narrow-surface coating material.

By way of such a resetting device, an automated return of the cutting tool into the starting position following the trimming of the narrow-surface coating material can be provided. This allows a repeatability of the trimming process. Since the resetting device is formed as an energy storage element or as a drive cylinder, it can store energy by way of the adjusting movement of the cutting tool, said energy being released again, following the trimming of the narrow-surface coating material, in order to return the cutting tool into the starting position.

The object is additionally achieved by a coating device for coating narrow surfaces of planar workpieces with a narrow-surface coating material, said coating device having a feed device for feeding the narrow-surface coating material and having a pressing device for pressing the narrow-surface coating material against the narrow surface of the workpiece, said coating device having a trimming device according to one of the previously described embodiments in order to trim the narrow-surface coating material. A coating device having such a trimming device allows a significant reduction of the processing times when coating narrow sides of planar workpieces. An interruption of the transport movement of the narrow-surface coating material and/or a feed movement of the coating device when trimming the narrow-surface coating material can be avoided by way of this trimming device. In this way, it can additionally be made possible to form high quality joints between two ends of the narrow-surface coating material and at the same time to achieve short process times.

In a preferred embodiment of the coating device, it can b e provided that this is CNC controlled or is formed as a CNC controlled processing center or is a component of a CNC controlled processing center. An automated control of the coating device and/or the trimming device can thus be made possible. By way of the CNC control or the integration of the coating device and/or trimming device into a CNC controlled processing center, the coating device and/or the trimming device can be moved in automated fashion along the narrow surfaces of the workpiece. Here, complex workpiece geometries can also be coated in automated fashion.

The object is furthermore achieved by a method for trimming a narrow-surface coating material using a trimming device, in particular a trimming device according to one of the previously described embodiments, wherein the method has the following steps:
the narrow-surface coating material is transported in a direction of movement to a cutting region of a cutting tool of the trimming device,
in order to trim the narrow-surface coating material, an adjusting movement of the cutting tool from a starting position is controlled, wherein the adjusting movement has at least one directional component directed in the direction of movement of the narrow-surface coating material,
simultaneously to the adjusting movement of the cutting tool, a cutting movement of the cutting tool is controlled and the narrow-surface coating material is severed, and
the cutting tool, following the trimming of the narrow-surface coating material, is returned to the starting position.

By way of this method, a trimming of the narrow-surface coating material without interruption of a transport movement of the narrow-surface coating material can be made possible, wherein the narrow-surface coating material can be trimmed to an optimal length, so that it can be applied in the necessary length to the narrow surface of the workpiece. Significantly shorter process times for trimming the narrow-surface coating material can thus be achieved.

In a preferred embodiment of the method, it can be provided that the adjusting movement of the cutting tool is performed with an adjusting speed that corresponds substantially to the transport speed of the narrow-surface coating material. In this way, a precise synchronization between the transport movement of the narrow-surface coating material and the adjusting movement of the cutting tool can be achieved.

In an advantageous further development of the method, it can be provided that the transport speed of the narrow-surface coating material in order to trim the narrow-surface coating material remains constant or the material is transported at a reduced transport speed. Here, it is not necessary to stop the transport movement of the narrow-surface coating material in order to perform a trimming operation, and therefore extremely short processing times for trimming the narrow-surface coating material can be achieved in this way. A cost optimized processing can thus be realized.

A particularly preferred embodiment of the method can provide that, in order to trim the narrow-surface coating material, a clamping device of the trimming device is transferred into a clamping position, in which the clamping device bears against or engages the narrow-surface coating material in a non-slip manner and at least the clamping device and the cutting tool are entrained by the transport movement of the narrow-surface coating material. In this way, a mechanical synchronization between the transport movement of the narrow-surface coating material and the adjusting movement of the cutting tool can be achieved, without the need for an additional electronic controller or sensors. Since the clamping device bears against or engages the narrow-surface coating material in a non-slip manner, the adjusting movement of the cutting tool can additionally be coordinated precisely with the transport movement of the narrow-surface coating material.

### BRIEF DESCRIPTION OF THE DRAWINGS

The invention and further advantageous embodiments and further developments thereof will be described and explained in greater detail hereinafter on the basis of the examples shown in the figures. The features to be inferred from the description and the figures can be applied in accordance with the invention individually or together in any combination. In the figures:

FIG. 1 shows a schematic illustration of a coating device with a trimming device,

FIG. 2 shows a detailed view of a clamping device of the trimming device according to FIG. 1,

FIG. 3 shows a sectional view of the trimming device according to FIG. 1 in a first method step of a trimming process,

FIG. 4 shows a sectional view of the trimming device in a second method step of the trimming process,

FIG. 5 shows a sectional view of the trimming device in a third method step of the trimming process, and

FIG. 6 shows a sectional view of the trimming device in a fourth method step of the trimming process.

### DESCRIPTION OF EMBODIMENTS

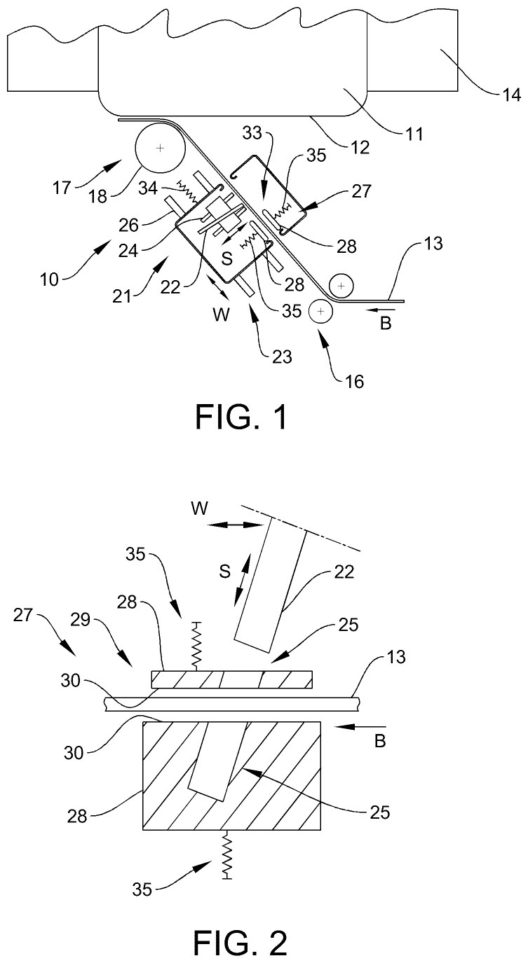

FIG. 1, in a heavily schematic illustration, shows a coating device 10 for coating narrow surfaces 12 of planar workpieces 11 with a narrow-surface coating material 13. A narrow-surface coating material 13 of this kind is also referred to as an edge strip or edge material. A coating device 10 of this kind can be provided both in a continuous feed process, in which the workpiece is moved relative to the coating device 10, and also can b e CNC controlled or can be part of a CNC controlled processing center.

The workpieces 11 to be coated are in particular formed at least in part from wood, wood materials, synthetic material, composite materials or the like. Such workpieces 11 are used for example in the field of furniture and component production. They can be constituted by a wide variety of workpieces 11, such as solid wood panels or particle boards, lightweight boards, sandwich boards, baseboards, profiles for profile wrapping and the like. The present invention is not limited, however, to workpieces 11 of this kind.

The coating device 10 comprises a support 14, on which the workpiece 11 rests during the coating process. This support 14 can be of fixed design, wherein the workpiece 11 can be placed in a manner held firmly in position on the support 14 and the coating device 10 is moved relative to the workpiece 11. In particular, the coating device 10 can be guided along the narrow surfaces 12 of the workpiece 11 in order to provide the narrow-surface coating material 13 on the narrow surface 12 of the workpiece 11. Here, the coating device 10 can be CNC controlled. It can also be provided that the coating device 10 is from the field of continuous feed processing, wherein the workpiece 11 is moved by the support 14 with a feed movement relative to the coating device 10 and the narrow-surface coating material 13 is applied against the narrow surface 12 of the workpiece 11. For example, the support 14 can be formed here as a conveying device.

The coating device 10 comprises a feed device 16 for continuously feeding the narrow-surface coating material 13. The feed device 16 feeds the narrow-surface coating material 3 to a pressing device 17. The pressing device 17 has, for example, a rotatably mounted pressing roll 18. The narrow-surface coating material 3 is pressed against the narrow surface 12 of the workpiece 11 by the pressing device 17. Alternatively, a plurality of pressing rolls or also a pressing device of different design can also be provided.

The narrow-surface coating material 13 is formed at least from two layers, wherein a layer associated with the workpiece 11 is formed as a function layer. This function layer can be, for example, an adhesive layer or a heat activatable adhesive free layer. The at least one further layer of the narrow-surface coating material 13 forms in particular a decorative layer. In order to form a permanent connection of the narrow-surface coating material 13 to the workpiece 11, the function layer is activated, for example heated to an activation temperature, by an activation device not shown in greater detail immediately before being pressed against the narrow surface 12 of the workpiece 11.

In order to trim the narrow-surface coating material 13, the coating device 11 has a trimming device 21. According to FIG. 1, the trimming device 21 is arranged downstream of the feed device 16 in the direction of movement B of the narrow-surface coating material 13. It can also be provided that the trimming device 21 is arranged before the feed device 16 in the direction of movement of the narrow-surface coating material 13. The trimming device 21 is additionally not necessarily a component of a coating device 10 of this kind but can also be used separately.

Due to the trimming device 21, the narrow-surface coating material 13 can be trimmed to an optimal length, so that it can be applied in a corresponding length to the narrow surface 12 of the workpiece 11. In particular if the narrow-surface coating material 13 is applied to the narrow surface 12 along the entire periphery of a workpiece 11, an exact abutment region between the two ends of the narrow-surface coating material 13 can be formed by the trimming device 21.

In order to form an exact abutment region, the trimming device 21 for example can have an edge detection device not shown in greater detail. This edge detection device detects a first end of the narrow-surface coating material 13 already applied to the narrow surface 12 in order to control the trimming process and trim the narrow-surface coating material 13 to an exactly required length. The narrow-surface coating material 13 can thus be individually adapted in respect of its length for a narrow side 12 of a workpiece 11 so that differences in the length of narrow sides 12 of different workpieces 11 do not take effect in the form of joint gaps or overlapping. The edge detection device can be connected to the trimming device 21 via an electronic controller and for example can be formed as a mechanical electrical or an optical electrical edge joint sensor.

The trimming device 21 comprises a cutting tool 22 for severing the narrow-surface coating material 13. This cutting tool 22 can be arranged both perpendicularly to the direction of movement B of the narrow-surface coating material 13 and at an angle at an incline to the direction of movement B of the narrow-surface coating material 13, as is shown in FIG. 1. Due to the inclined orientation, so called scarfed edge joints can be formed. The cutting tool 22 can be any cutting means, for example a circular saw.

The trimming device 21 has an adjusting device 23, by means of which the cutting tool 22 can perform a cutting movement S and an adjusting movement W in order to trim the narrow-surface coating material 13. In order to perform the cutting movement S of the cutting tool 22, the adjusting device 23 has a first guide 24. The cutting movement S is in particular a feed movement of the cutting tool 22 in the direction of the narrow-surface coating material 13 and comprises the severing of the narrow-surface coating material 13. The first guide 24 in particular allows a cutting movement S which is oriented substantially perpendicularly or inclined at an angle to the direction of movement B of the narrow-surface coating material 13. The first guide 24 is formed for example as a linear guide.

In order to perform the adjusting movement W of the cutting tool 22, the adjusting device 23 has a second guide 26. By way of the second guide 26, a movement of the cutting tool 22 that is oriented in the direction of the direction of movement B of the narrow-surface coating material 13, in particular parallel to the direction of movement B, is provided. This second guide 26 can likewise be formed as a linear guide.

The first guide 24 and the second guide 26 can be arranged relative to one another in such a way that a cross guide is formed. By way of this cross guide, a biaxial guide 24, 26 for controlling the cutting tool 22 is formed. By way of this arrangement of the guides 24, 26 relative to one another, the adjusting movement W and the cutting movement S can be performed simultaneously, that is to say at the same time or rather in a superposed manner. In this way, the cutting tool 22 can perform the adjusting movement W along the second guide 26 in the direction of the direction of movement B of the narrow-surface coating material 13 and, while the adjusting movement W is being performed, simultaneously can perform the cutting movement S for severing the narrow-surface coating material 13.

This simultaneous control of the adjusting movement W and of the cutting movement S of the cutting tool 22 allows the narrow-surface coating material 13 to be trimmed without the transport movement of the narrow-surface coating material 13 having to be interrupted and without the need for the feed to be stopped for the coating device 10. This means that the transport speed of the narrow-surface coating material 13 remains constant or is only slightly reduced for the trimming. A complete stopping of the feeding transport movement of the narrow-surface coating material 13 is therefore not necessary for the trimming.

In order for it to be possible to perform the cutting movement S during the adjusting movement W, the speed of the adjusting movement W must be coordinated or synchronized with the transport speed of the narrow-surface coating material 13. For this purpose, the adjusting device 23 or the cutting tool 22 is operatively connected to a drive device 33. As shown schematically in FIG. 1, this drive device 33 is formed as a clamping device 27. This comprises two mutually opposed clamping elements 28, which can be transferred from a material pass through position 29 to a clamping position 31. The clamping elements 28 can comprise control elements 35, for example energy storage elements or a drive, which control the transfer between the material pass through position 29 and the clamping position 31. The narrow-surface coating material 13 is guided between the two clamping elements 28 so that the clamping elements 28 can be brought into abutment with the narrow-surface coating material 13 passing through, by way of the transfer into the clamping position 31. In particular, the clamping elements 28 in the clamping position 31 bear in a non-slip manner against the narrow-surface coating material 13. The clamping elements 28 in the clamping position 31 preferably bear against the two broad sides of the narrow-surface coating material 13. The contact faces 30 of the clamping elements 28 pointing towards the narrow-surface coating material 13 can have a structuring or profiling or can be formed from a material having a high coefficient of friction, for example a rubber-like material. In this way, the static friction between the clamping elements 28 and the narrow-surface coating material 13 can be increased in order to ensure the non-slip state.

By bringing the clamping elements 28 into abutment with the narrow-surface coating material 13, i.e., by transferring them from the material pass through position 29 into the clamping position 31, the transport movement of the narrow-surface coating material 13 is transferred in a non-slip manner to the clamping device 27, so that this accelerates to the transport speed and is entrained by the narrow-surface coating material 13. In this way, the clamping device 27 is entrained by the transport movement of the narrow-surface coating material 13 until the clamping elements 28 are transferred again from the clamping position 31 into the material pass through position 29. Since the clamping device 27 is operatively connected to the adjusting device 23 or the cutting tool 22, the transport movement of the narrow-surface coating material 13 is transferred to the cutting tool 22, whereby the adjusting movement W of the cutting tool 22 is controlled. Due to the operative connection between the clamping device 27 and the cutting tool 22, the speed of the adjusting movement W of the cutting tool 22 is synchronized directly with the transport speed of the narrow-surface coating material 13. The cutting tool 22 can thus perform the cutting movement S during the adjusting movement W in order to sever the narrow-surface coating material 13.

As shown in the detailed view according to FIG. 2, the two clamping elements 28 each have a recess 25, in particular a slotted recess, which are arranged correspondingly to one another. The recesses 25 are preferably adapted to a geometry of the cutting tool 22. When the clamping elements 28 in the clamping position 31 act on the narrow-surface coating material 13 in a manner held firmly in place, the cutting tool 22 can thus dip into the recesses 25 in order to sever the narrow-surface coating material 13 fixed between the clamping elements 28.

The drive device 33 can alternatively or also additionally be formed as a drive motor, a drive cylinder, an energy storage element or a comparable adjusting drive and can control the adjusting movement W and/or the cutting movement S of the cutting tool 22. In particular, it can be provided that such a drive device 33 is provided additionally to the clamping device 27. For example, the drive device can assist the adjusting movement W and/or cutting movement S or can control a preliminary acceleration of the cutting tool 22 before the clamping device 27 is transferred into the clamping position 31. It can also be provided that the adjusting movement W is controlled by the clamping device 27 and the cutting movement S is controlled by a separate drive device 33. Alternatively, to perform the cutting movement S, a mechanical drive transfer can be provided. The drive device 33 can additionally have a synchronization device, for example a sensor, which, via a controller, synchronizes the speed of the adjusting movement W of the cutting tool 22 with the transport speed of the narrow-surface coating material 13.

Once the narrow-surface coating material 13 has been trimmed or once the adjusting movement W and/or the cutting movement S has been performed, the cutting tool 22 or the trimming device 21 can be returned to a starting position 32. For this purpose, the trimming device 21 has a resetting device 34. This resetting device 34 can be an energy storage element, for example a spring element or a pressure cylinder, which stores energy as a result of the adjusting movement W and/or the cutting movement S having been performed and releases this energy again in order to perform the resetting movement. Alternatively, the resetting device 34 can also be a drive motor or a comparable resetting drive, which controls the resetting movement of the cutting tool 22 into the starting position 32.

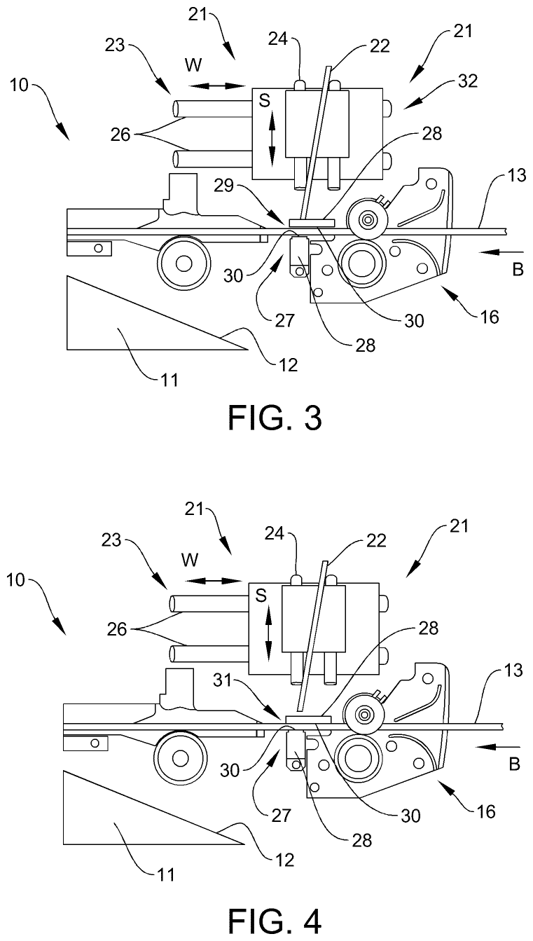

Various method steps of the trimming process by the trimming device 21 are shown schematically in FIGS. 3 to 6. FIG. 3 shows the trimming device 21 in a first method step, in which the trimming device 21 is arranged in the starting position 3 2. In this starting position 32, the two clamping elements 28 are arranged in the material pass through position 29, so that the narrow-surface coating material 13 is transported in the direction of movement B relative to the trimming device 21. The trimming device 21 is at a standstill in this starting position 32.

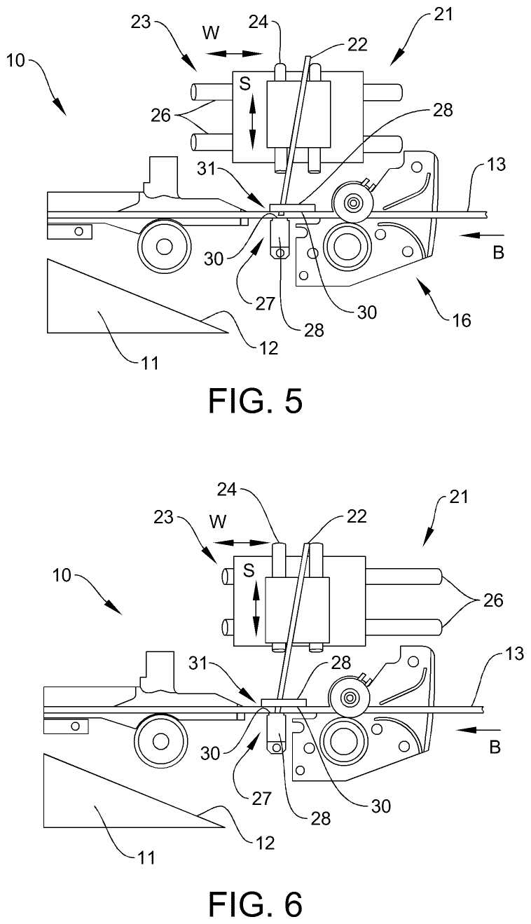

FIG. 4 shows the trimming device 21 in a second method step in which the clamping elements 28 of the clamping device 27 are arranged in the clamping position 31 and bear with the contact faces 30 in a non-slip manner against the narrow-surface coating material 13. In this way, the clamping device 27 is entrained by the transport movement of the narrow-surface coating material 13. Since the clamping device 27 is operatively connected to the cutting tool 22, the cutting tool 22 is entrained together with the clamping device 27 and performs the adjusting movement W. This is shown in FIG. 5. The adjusting movement W is a guided movement along the second guide 26, which is provided in particular parallel to the direction of movement B of the narrow-surface coating material 13. Here, the cutting tool 22 performs the adjusting movement Win particular at the same speed as the transport speed of the narrow-surface coating material 13. The adjusting movement W of the cutting tool 22 is consequently performed synchronously to the transport movement of the narrow-surface coating material 13. At the same time as the adjusting movement W, the cutting movement S of the cutting tool 22 is controlled, i.e., the cutting tool 22 is moved along the first guide 24 in the direction of the narrow-surface coating material 13, in order to sever the narrow-surface coating material 13.

In FIG. 6, the end of the trimming process is shown, wherein the cutting tool 22 is moved as far as an end of the first guide 24 and an end of the second guide 26 in order to fully sever the narrow-surface coating material 13. Here, the cutting tool 22 is dipped into the recesses 25 of the clamping elements 28 and the narrow-surface coating material 13 is fully severed. The cutting tool 22 is then firstly reset along the first guide 24 by the resetting device 34 and then transferred back into the starting position 32 along the second guide 26, so that the narrow-surface coating material 13 can be trimmed again.

Following the trimming, the trimmed end of the narrow-surface coating material 13 is transported to the pressing device 17 in order to be pressed against the narrow surface 12 of the workpiece 11, in particular with an exact joint to the other end of the narrow-surface coating material 13.

### LIST OF REFERENCE NUMBERS

10. coating device

11. workpiece

12. narrow surface

13. narrow-surface coating material

14. support

15.

16. feed device

17. pressing device

18. pressing roll

19.

20.

21. trimming device

22. cutting tool

23. adjusting device

24. first guide

25. recess

26. second guide

27. clamping device

28. clamping element

29. material pass through position

30. contact face

31. clamping position

32. starting position

33. drive device

34. resetting device

35. control elements

B direction of movement

S cutting movement

W adjusting movement

1. A trimming device (21), in particular for a coating device (10) for coating narrow surfaces (12) of planar workpieces (11), having a cutting tool (22) by means of which a cutting movement (S) can be performed in order to trim a narrow-surface coating material (13), wherein the cutting tool (22) comprises a cutting region to which the narrow-surface coating material (13) can be transported in a direction of movement (B),
characterized in that
an adjusting device (23) is provided, by means of which an adjusting movement (W) of the cutting tool (22) can be controlled in order to trim the narrow-surface coating material (13), wherein the adjusting movement (W) has at least one directional component directed in the direction of movement (B) of the narrow-surface coating material (13).

2. The trimming device according to claim 1,
characterized in that
the adjusting device (23) comprises at least one guide (24, 26), preferably at least one linear guide or cross guide, by means of which a guided adjusting movement (W) and/or cutting movement (S) of the cutting tool (22) is provided.

3. The trimming device according to claim 1 or 2,
characterized in that
the adjusting movement (W) of the cutting tool (22) and the cutting movement (S) of the cutting tool (22) can be performed simultaneously.

4. The trimming device according to one of the preceding claims,
characterized in that
the adjusting movement (W) of the cutting tool (22) is provided substantially parallel to the direction of movement (B) of the narrow-surface coating material (13).

5. The trimming device according to one of the preceding claims,
characterized in that
the adjusting device (23) comprises at least one drive device (33) which controls at least the adjusting movement (W) of the cutting tool (22) from a starting position (32), wherein a speed of the adjusting movement (W) of the cutting tool (22) can be adapted to a transport speed of the narrow-surface coating material (13).

6. The trimming device according to claim 5,
characterized in that
the drive device (33) is formed as an energy storage element, drive cylinder, drive motor or as a comparable adjusting drive, and a synchronization device is preferably provided which adapts the speed of the adjusting movement (W) of the cutting tool (22) to the transport speed of the narrow-surface coating material (13).

7. The trimming device according to claim 5,
characterized in that
the drive device (33) is formed as a clamping device (27), which, in a clamping position (31), bears against or engages the narrow-surface coating material (13) in a non-slip manner so that the clamping device (27) in the clamping position (31) can be entrained by the transport movement of the narrow-surface coating material (13).

8. The trimming device according to claim 7,
characterized in that
the clamping device (27) comprises at least two mutually opposed clamping elements (28), which can be transferred from a material pass through position (29) into the clamping position (31), wherein the narrow-surface coating material (13) is transportable in the material pass through position (29) between the clamping elements (28) and the clamping elements (28) in the clamping position (31) bear against or engage the narrow-surface coating material (13).

9. The trimming device according to claim 8,
characterized in that
the at least two clamping elements (28) comprise recesses (25) corresponding to one another into which the cutting tool (22) dips at least in part while the cutting movement (S) is being performed.

10. The trimming device according to one of the preceding claims,
characterized in that
the adjusting device (23) comprises at least one resetting device (34), preferably an energy storage element, a drive cylinder, a drive motor or a comparable resetting drive, by means of which a resetting movement of the cutting tool (22) into the starting position (32) can be controlled following the trimming of the narrow-surface coating material (13).

11. A coating device (10) for coating narrow surfaces (12) of planar workpiece s (11) with a narrow-surface coating material (13), having a feed device (16) for fee ding the narrow-surface coating material (13), and having a pressing device (17) for pressing the narrow-surface coating material (13) against the narrow surface (12) of the workpiece (11),
characterized in that
a trimming device (21) according to one of claims 1 to 10 is provided in order to trim the narrow-surface coating material (13).

12. The coating device according to claim 11,
characterized in that
the coating device (10) is CNC controlled or is formed as a CNC controlled processing center or is a component of a CNC controlled processing center.

13. A method for trimming a narrow-surface coating material (13) using a trimming device (21), in particular a trimming device (21) according to one of claims 1 to 10, the method comprising the following steps that
the narrow-surface coating material (13) is transported in a direction of movement (B) to a cutting region of a cutting tool (22) of the trimming device (21),
in order to trim the narrow-surface coating material (13), an adjusting movement (W) of the cutting tool (22) from a starting position (32) is controlled, wherein the adjusting movement (W) has at least one directional component directed in the direction of movement (B) of the narrow-surface coating material (13),
simultaneously to the adjusting movement (W) of the cutting tool (22), a cutting movement (S) of the cutting tool (22) is controlled and the narrow-surface coating material (13) is severed, and
the cutting tool (22) is returned to the starting position (32) following the trimming of the narrow-surface coating material (13).

14. The method according to claim 13,
characterized in that
the adjusting movement (W) of the cutting tool (22) is performed with an adjusting speed that corresponds substantially to the transport speed of the narrow-surface coating material (13).

15. The method according to claim 13 or 14,
characterized in that
the transport speed of the narrow-surface coating material (13) in order to trim the narrow-surface coating material (13) remains constant or the material is transported at a reduced transport speed.

16. The method according to one of claims 13 to 15,
characterized in that
in order to trim the narrow-surface coating material (13), a clamping device (27) of the trimming device (21) is transferred into a clamping position (31), in which the clamping device (27) bears against or engages the narrow-surface coating material (13) in a non-slip manner and at least the clamping device (27) and the cutting tool (22) are entrained by the transport movement of the narrow-surface coating material (13).
